(19) United States
(12) Patent Application Publication
(10) Pub. No.: US 2009/0078909 A1
(43) Pub. Date: Mar. 26, 2009

(54) Method for storing hydrogen

(75) Inventors: Minoru Yagi, Tokyo (JP); Toru Masaoka, Tokyo (JP)

Correspondence Address: POSZ LAW GROUP, PLC, 12040 SOUTH LAKES DRIVE, SUITE 101, RESTON, VA, 20191, US

(73) Assignee: KURITA WATER INDUSTRIES LTD., Shinjuku-ku, Tokyo (JP)

(21) Appl. No.: 11/920,055

(22) PCT Filed: Mar. 27, 2006
(86) PCT No.: PCT/JP2006/306097

§ 371 Date: Aug. 21, 2008

(30) Foreign Application Priority Data
May 13, 2005 (JP) 2005-141768
Aug. 4, 2005 (JP) 2005-226187

(51) Int. Cl. C01B 3/00

(52) U.S. Cl. 252/182.12; 252/182.32

(57) ABSTRACT

An object is to provide a method for storing hydrogen that allows hydrogen to be easily stored and easily released, and the method comprises cooling a liquid mixture of a carbon compound capable of forming a molecular compound and a protic polar solvent while bringing hydrogen into contact with the liquid mixture, to form thereby a solid substance having hydrogen enclosed therein; as a result, the carbon compound capable of forming a molecular compound becomes caged in a clathrate that does not readily enclose hydrogen, unless under ultrahigh pressure; the carbon compound forms a molecular compound with the hydrogen, while a clathrate capable of enclosing the hydrogen therein under high-pressure conditions also forms a hydrogen clathrate, thereby allowing to increase hydrogen storage density; and the hydrogen can be stored thus by maintaining the state of the solid substance, and can be easily extracted by simply dissolving the solid substance in water.

### TECHNICAL FIELD

The present invention relates to a method for storing hydrogen that can be suitably used in a fuel cell system or the like.

### BACKGROUND ART

New clean energy systems based on using hydrogen as an energy medium have been proposed as an approach for tackling the global environmental problem posed in recent years by carbon dioxide (CO₂) emissions. Fuel cells, which are an energy conversion technology where chemical energy released through bonding of hydrogen and oxygen is extracted as electric energy, have received attention as one of the major next-generation technologies for power sources that should supersede automobile gasoline engines, domestic on-site power generation, and DC power supply equipment in the IT field.

### DISCLOSURE OF THE INVENTION

### Problem to be Solved by the Invention

However, storage and transport remain chief problems in the handling of hydrogen fuel. Various methods have been proposed for storing hydrogen, including a method for storing gaseous hydrogen in high-pressure gas cylinders. Such high-pressure storage, although simple, requires thick-walled containers. That results in heavier containers and less efficient storage and transport, which makes such an approach difficult to implement, for instance, in automobiles, where weight is a major concern. When hydrogen is stored in liquid form, on the other hand, storage and transport efficiency improve vis-à-vis that of gaseous hydrogen, but the production of liquid hydrogen is economically problematic in that, for instance, it requires high-purity hydrogen, and involves a low liquefaction temperature of −252.6° C., which necessitates special containers for ultra-low temperatures.

The use of hydrogen storage alloys has also been proposed, but the alloys themselves are heavy, while lightweight Mg-based hydrogen storage alloys are problematic in that the usage temperature at which hydrogen is released is high, around 300° C.

Using porous carbon materials such as carbon nanotubes or the like has also been proposed. These materials, however, have many problems, including poor hydrogen storage repeatability as well as the difficulties involved in carbon nanotube production.

Methods have also been proposed (International Patent Publication 2004/000857) in which hydrogen is brought into contact, under ambient or high pressure, with a host compound capable of forming a hydrogen inclusion compound. Such hydrogen inclusion compounds are problematic in that their hydrogen storage density is not particularly high.

Other proposed methods (hydrogen hydrate methods) involve storing hydrogen by bringing into contact water and hydrogen under high pressure and cooling them, using water as a host. Such a method has an impracticality problem, since it requires bringing into contact water with hydrogen under an ultrahigh pressure of several thousands of atmospheres, at a low temperature. As a way of solving these problems, it has been reported that a hydrogen hydrate can be manufactured with high-pressure hydrogen up to several tens of atmospheres, by blending water with an organic compound such as tetrahydrofuran or the like. Such a method is problematic in that the afforded hydrogen storage density is not particularly high.

In the light of the above problems, it is an object of the present invention to propose a method for storing hydrogen that allows storing and releasing hydrogen easily.

### Means for Solving the Problem

The method for storing hydrogen of the present invention comprises: forming a solid substance in which hydrogen is enclosed by bringing the hydrogen into contact with a liquid mixture of a carbon compound capable of forming a molecular compound and a protic polar solvent, while a temperature of them is kept at a predetermined temperature (Invention 1). By enclosing a carbon compound capable of forming a molecular compound in a clathrate of protic polar solvent molecules that do not readily form a hydrogen clathrate, except under ultrahigh pressure, such that hydrogen is taken up in the clathrate through formation of a molecular compound with the carbon compound; and by forming a hydrogen clathrate through another clathrate that can form a hydrogen clathrate comparatively readily, such a method allows incorporating hydrogen into a clathrate of virtually all protic polar solvent molecules, which makes it possible as a result to increase the storage density of hydrogen and to store hydrogen by maintaining the state of a solid substance. Thus, hydrogen can be extracted readily by simply dissolving the solid substance.

The liquid mixture of a carbon compound capable of forming a molecular compound and a protic polar solvent is a solution in which the carbon compound is dissolved in the protic polar solvent (Invention 2).

Specifically, the hydrogen in gaseous form is brought into contact, under pressurized conditions, with the liquid mixture of the carbon compound and the protic polar solvent (Invention 3). Upon brining into contact the hydrogen with the liquid mixture of the carbon compound and the protic polar solvent, in particular, the pressure is preferably not greater than 250 MPa, and the temperature ranges preferably from −200 to 50° C. (Invention 4).

Preferably, the carbon compound capable of forming the molecular compound is a host compound that forms an inclusion compound (Invention 5); in particular, the host compound is preferably at least one compound selected from the group consisting of monomolecular host compounds, multimolecular host compounds, and polymeric host compounds (Invention 6). The storage density of hydrogen can be enhanced by using such a host compound. Preferably, the carbon compound capable of forming a molecular compound is liquid carbon dioxide or a non-polar solvent (Invention 7).

### ADVANTAGEOUS EFFECT OF THE INVENTION

The reasons for the necessity of ultrahigh pressures for forming a hydrogen hydrate are as follows. When water and hydrogen are kept in contact with each other under high pressure, there form a complex of two types of clathrate having different volumes, i.e. a clathrate having a dodecahedral structure comprising 12 pentagons, based on water molecules, and a clathrate having a hexadecahedral structure comprising 12 pentagons and 4 hexagons. Among the complex of these two types of clathrate, hydrogen is enclosed under a pressure of several tens of atmospheres in the small-volume clathrate having the dodecahedral structure, but is hardly enclosed in the large-volume clathrate having the hexadecahedral structure. The latter clathrate becomes unstable as a result, and hence ultrahigh pressures are conventionally required for the formation of a hydrogen hydrate in such hexadecahedral clathrate. On the other hand, it has been reported that hydrogen hydrates can be produced with high-pressure hydrogen up to several tens of atmospheres, by blending water with an organic compound such as tetrahydrofuran or the like. However, that is presumably because tetrahydrofuran is selectively enclosed in a clathrate having a hexadecahedral structure under a pressure of several tens of atmospheres, whereby hydrogen becomes enclosed in the clathrate having a dodecahedral structure, thus stabilizing the complex of the hydrogen hydrate. Therefore, the storage density of hydrogen should arguably not be particularly high, since the hydrogen hydrate is formed only by the clathrate having the dodecahedral structure.

In light of the above, and as a result of diligent research, the inventors found out that a host compound or the like that forms an inclusion compound becomes selectively enclosed in a large-volume clathrate having a hexadecahedral structure by dissolving in water the host compound and maintaining the resulting solution in contact with hydrogen under high pressure, thereby forming a hydrate in which hydrogen is enclosed in the host compound or the like that is enclosed in the clathrate (in the present description such clathrates in which hydrogen is enclosed in a host compound are also referred to as hydrogen hydrates, for convenience). Of course, the clathrate having a dodecahedral structure also forms the hydrogen hydrate.

Similarly, when mixing liquid carbon dioxide or a non-polar solvent with a protic polar solvent and keeping in contact the resulting liquid mixture with hydrogen under high pressure, there appears to form a hydrogen clathrate in which a clathrate of the protic polar solvent molecules encloses hydrogen and the liquid carbon dioxide or the non-polar solvent in which hydrogen is enclosed.

Forming such a hydrogen clathrate (hydrate) allows storing hydrogen by forming a hydrogen clathrate (hydrate) at a substantially lower pressure than in a conventional case. Moreover, hydrogen becomes enclosed in most of the clathrate, which allows increasing the storage density of hydrogen. Moreover, such a hydrogen clathrate (hydrate) behaves essentially like ice, and hence hydrogen can be easily extracted simply by keeping the hydrogen clathrate at room temperature and dissolving it.

### BEST MODE FOR CARRYING OUT THE INVENTION

The present invention is explained in detail below.

Basically, the method for storing hydrogen of the present invention comprises the step of forming a solid substance in which hydrogen is enclosed by maintaining a state in which hydrogen is in contact, under high pressure and/or at low temperature, with a liquid mixture of a protic polar solvent and a carbon compound capable of forming a molecular compound.

In the present invention, the molecular compound is a compound having the ability of enclosing hydrogen, being formed through bonding of two or more individually stable compounds by means of relatively weak interactions other than a covalent bond, typified by hydrogen bonds, Van der Waals forces and the like. The molecular compound may be a hydrate, solvate, addition compound, inclusion compound or the like.

The carbon compound capable of forming a molecular compound does not include carbon compounds comprising only carbon atoms, such as graphite, carbon nanotubes or fullerenes, but includes organometallic compounds comprising a metallic component. As the carbon compound there may be used, for instance, a host compound that forms an inclusion compound, liquid carbon dioxide or a non-polar solvent that form a molecular compound with hydrogen, or the like. As the host compound there may be used at least one compound selected from the group consisting of (1) monomolecular host compounds, (2) multimolecular host compounds and (3) polymeric host compounds, or (4) other host compounds.

(1) Monomolecular Host Compounds

Monomolecular host compounds include, for instance, cyclodextrins, crown ethers, cryptands, cyclophanes, azacyclophanes, calixarenes, cyclotriveratrylenes, spherands and cyclic oligopeptides.

(2) Multimolecular Host Compounds

Multimolecular host compounds include, for instance, ureas, thioureas, deoxycholic acids, cholic acids, perhydrotriphenylenes, tri-o-thymotides, bianthryls, spirobifluorenes, cyclophosphazenes, monoalcohols, diols, acetylene alcohols, hydroxybenzophenones, phenols, bisphenols, trisphenols, tetrakisphenols, polyphenols, naphthols, bis-naphthols, diphenylmethanols, carboxylic amides, thioamides, bixanthenes, carboxylic acids, imidazoles, hydroquinones and amino acids.

(3) Polymeric Host Compounds

Polymeric host compounds include, for instance, celluloses, starch, chitins, chitosans, polyvinyl alcohols, polymers having a core of 1,1,2,2-tetrakis phenyl ethane and polyethylene glycol arms, and polymers having a core of α,α,α′,α′-tetrakis phenyl xylene and polyethylene glycol arms.

(4) Other Host Compounds

Other organic compounds forming hydrogen inclusion compounds include, for instance, organophosphorus compounds, organosilicon compounds and the like. Organometallic compounds having host compound characteristics include, for instance, organoaluminum compounds, organotitanium compounds, organoboron compounds, organozinc compounds, organoindium compounds, organogallium compounds, organotellurium compounds, organotin compounds, organozirconium compounds, and organomagnesium compounds. As the organometallic compound there may be used a metal salt of an organic carboxylic acid, an organometallic complex or the like. The organometallic compound, however, is not particularly limited to any of the above compounds.

Among these, preferably used host compounds are those that dissolve readily in protic polar solvents, for instance cyclodextrins, crown ethers, cyclic oligopeptides, ureas, thioureas, deoxycholic acids, cholic acids, phenols, carboxylic acids, imidazoles, hydroquinones and amino acids. These host compounds may be used singly or in combinations of two or more.

Non-polar solvent include, for instance, hydrocarbons such as hexane, cyclohexane, benzene, toluene or the like; halides such as dichloromethane, chloroform, carbon tetrachloride, dichlorobenzene or the like; or ethers such as dimethyl ether, diethyl ether, tetrahydrofuran, 1,4-dioxane or the like.

Among these, preferable non-polar solvents that can be used are those that dissolve readily in protic polar solvents, for instance cyclohexane, dimethyl ether, diethyl ether or the like. The non-polar solvent may be used singly or in combinations of two or more. When used in mixtures of two or more, the mixing ratios of the non-polar solvents are not particularly limited.

The protic polar solvent is not particularly limited,

provided that it can form a clathrate capable of enclosing hydrogen, and may be, for instance, water; amines such as a hydroxylamine or the like; glycols; alcohols such as a glycerin, a cyclic alcohol, amino alcohols, polyhydric alcohols; oxyacids; and amides.

These protic polar solvents may be used singly or in combinations of two or more. When used as a mixture of two or more, the combinations or mixing ratios of the protic polar solvents are not particularly limited.

An explanation follows next on the method for storing hydrogen of the present invention using host compounds, liquid carbon dioxide or non-polar solvents such as those described above.

Firstly, the above host compound is dissolved in the protic polar solvent. If the solution amount of the host compound is too small, the enhancing effect on hydrogen storage density is insufficient, while the pressure reducing effect for the formation of the hydrogen clathrate decreases as well; on the other hand, if the solution amount is excessive, dissolution of the host compound becomes itself difficult. Preferably, therefore, the solution amount is set to about 1 to about 50 wt %.

When a non-polar solvent is used, the non-polar solvent is mixed with the protic polar solvent. The mixing ratio of non-polar solvent and protic polar solvent may be suitably adjusted to a mixing ratio that allows enhancing hydrogen storage density and reducing the pressure for hydrogen clathrate formation. When liquid carbon dioxide is used, the liquid carbon dioxide is mixed with one or two or more protic polar solvents under high pressure and at low temperature. When using liquid carbon dioxide, the pressure and temperature conditions may be suitably adjusted to conditions that allow mixing of the liquid carbon dioxide and the protic polar solvent.

Next, the host compound and hydrogen are brought into contact by placing a protic polar solvent in which the host compound is dissolved in a hydrogen gas atmosphere under pressurized conditions. The hydrogen gas is preferably high-purity hydrogen gas, although a mixed gas of hydrogen gas and other gases may also be used when employing a host compound having selective inclusion ability towards hydrogen.

When using liquid carbon dioxide or a non-polar solvent, hydrogen is brought into contact with the liquid carbon dioxide or the non-polar solvent by placing a protic polar solvent with which the liquid carbon dioxide or the non-polar solvent is mixed, in a hydrogen gas atmosphere under pressurized conditions. Preferably, high-purity hydrogen gas is used as the hydrogen gas.

Whether or not there forms a hydrogen clathrate depends on the relationship between the pressure and temperature of the hydrogen gas. Accordingly, a lower hydrogen gas pressure is sufficient as the temperature becomes lower, the pressure ranging ordinarily herein from 1.0×10⁻¹⁰ to 200 MPa, from 0.1 to 70 MPa in practice, and preferably, in particular, from 0.2 to 10 MPa. The pressure of hydrogen gas when using liquid carbon dioxide may be suitably adjusted to a pressure that allows carbon dioxide to exist in liquid state.

The temperature when bringing into contact the host compound and hydrogen is not particularly limited, provided that it is a temperature at which crystals of hydrogen clathrate form under the above-described pressure. In particular, hydrogen becomes readily enclosed in the clathrate of protic polar solvent molecules through dissolution of the host compound, and hence the temperature may be room temperature provided that the pressure is of about 5 MPa. Specifically, the temperature may be suitably adjusted to fall within a range of −200 to 50° C., on the basis of the above relationship vis-à-vis pressure. When a non-polar solvent is used, also, the temperature range may be suitably adjusted on the basis of the above relationship vis-à-vis pressure. When liquid carbon dioxide is used, the temperature when bringing into contact the liquid carbon dioxide and hydrogen may be suitably adjusted to a temperature that allows carbon dioxide to exist in liquid state.

The time during which the protic polar solvent having dissolved therein the host compound is in contact with hydrogen gas is not particularly limited, but, in terms of working efficiency, ranges preferably from about 0.01 to about 24 hours. When using liquid carbon dioxide or a non-polar solvent, the time during which hydrogen is in contact with a liquid mixture of the liquid carbon dioxide or the non-polar solvent with the protic polar solvent may be suitably adjusted to such a contact time that allows sufficient hydrogen clathrate formation.

A solid hydrogen clathrate can be obtained by bringing thus into contact hydrogen with a liquid mixture of the carbon compound and the protic polar solvent. Hydrogen may be extracted from the obtained solid hydrogen clathrate simply by dissolving the hydrogen clathrate in water. Hydrogen can thus be easily extracted from the hydrogen clathrate.

### EXAMPLES

The present invention is explained in more detail based on the examples below. Unless departing from the scope thereof, the present invention is not meant in any way to be limited to or by the following examples.

### Example 1

A host compound aqueous solution was prepared by dissolving 5 g (0.05 mol) of the hydroquinone 1,4-dihydroxybenzene in 100 mL of water as a protic polar solvent. The obtained host compound aqueous solution was sealed in a high-pressure vessel, was purged with hydrogen gas, and was held under 10 MPa at 4° C. for 10 hours, to yield crystals of hydrogen clathrate (hydrate).

### Example 2

A host compound glycerin solution was prepared by dissolving 5 g (0.05 mol) of the hydroquinone 1,4-dihydroxybenzene in 100 mL of glycerin as a protic polar solvent. The obtained host compound glycerin solution was sealed in a high-pressure vessel, was purged with hydrogen gas, and was held under 10 MPa at 7° C. for 10 hours, to yield crystals of hydrogen clathrate.

### Example 3

A host compound aqueous solution was prepared by dissolving 5 g (0.05 mol) of the hydroquinone 1,4-dihydroxybenzene in 100 mL of a mixture of water and glycerin (mixing ratio=50:50). The obtained host compound solution was sealed in a high-pressure vessel, was purged with hydrogen gas, and was held under 8 MPa at 10° C. for 10 hours, to yield crystals of hydrogen clathrate.

### Example 4

A diethyl ether aqueous solution was prepared by dissolving 7 g (0.09 mol) of the non-polar solvent diethyl ether in 100 mL of water as a protic polar solvent. The obtained diethyl ether aqueous solution was sealed in a high-pressure vessel, was purged with hydrogen gas, and was held under 10 MPa at 6° C. for 10 hours, to yield crystals of hydrogen clathrate (hydrate).

### Example 5

A diethyl ether glycerin solution was prepared by dissolving 3 g (0.04 mol) of the non-polar solvent diethyl ether in 100 mL of glycerin as a protic polar solvent. The obtained diethyl ether glycerin solution was sealed in a high-pressure vessel, was purged with hydrogen gas, and was held under 7 MPa at 15° C. for 10 hours, to yield crystals of hydrogen clathrate.

### Example 6

A diethyl ether solution was prepared by dissolving 5 g (0.07 mol) of the non-polar solvent diethyl ether in 100 mL of a mixture of water and glycerin (mixing ratio=50:50). The obtained diethyl ether solution was sealed in a high-pressure vessel, was purged with hydrogen gas, and was held under 5 MPa at 10° C. for 10 hours, to yield crystals of hydrogen clathrate.

### INDUSTRIAL APPLICABILITY

The method for storing hydrogen of the present invention can be ideally used as a direct energy source in fuel cells or the like.

1. A method for storing hydrogen, comprising: forming a solid substance in which hydrogen is enclosed by bringing the hydrogen into contact with a liquid mixture of a carbon compound capable of forming a molecular compound and a protic polar solvent, while a temperature of them is kept at a predetermined temperature.

2. The method for storing hydrogen according to claim 1, wherein the liquid mixture of a carbon compound capable of forming a molecular compound and a protic polar solvent is a solution of the carbon compound dissolved in the protic polar solvent.

3. The method for storing hydrogen according to claim 1, wherein the hydrogen in gaseous form is brought into contact, under pressurized conditions, with the liquid mixture of a carbon compound and a protic polar solvent.

4. The method for storing hydrogen according to claim 3, wherein upon brining into contact the hydrogen and the liquid mixture of a carbon compound and a protic polar solvent the pressure is not greater than 250 MPa and the temperature ranges from −200 to 50° C.

5. The method for storing hydrogen according to claim 1, wherein the carbon compound capable of forming a molecular compound is a host compound that forms an inclusion compound.

6. The method for storing hydrogen according to claim 5, wherein the host compound is at least one compound selected from the group consisting of monomolecular host compounds, multimolecular host compounds, and polymeric host compounds.

7. The method for storing hydrogen according to claim 1, wherein the carbon compound capable of forming a molecular compound is liquid carbon dioxide or a non-polar solvent.
